(19) United States
(12) Patent Application Publication
(10) Pub. No.: US 2014/0187736 A1
(43) Pub. Date: Jul. 3, 2014

(54) Branched Polycarbonate and Method for Preparing the Same

(71) Applicant: Cheil Industries Inc., Gumi-si (KR)

(72) Inventors: Jin Yong BAE, Uiwang-si (KR); Kyu Buem CHOI, Uiwang-si (KR); Su Jeong SONG, Uiwang-si (KR); Dong Geun LEE, Uiwang-si (KR); Ho Sub LIM, Uiwang-si (KR)

(73) Assignee: Cheil Industries Inc., Gumi-si (KR)

(21) Appl. No.: 14/105,369

(22) Filed: Dec. 13, 2013

(30) Foreign Application Priority Data
Dec. 28, 2012 (KR) 10-2012-0157678

(51) Int. Cl. C08G 64/08

(52) U.S. Cl. CPC C08G 64/083
USPC 528/167

(57) ABSTRACT

A method for preparing branched polycarbonate includes: preparing a first raw material by mixing and reacting an aromatic dihydroxy compound, diaryl carbonate, and about 60 ppb (weight) to about 140 ppb (weight) of a catalyst with respect to the amount of aromatic dihydroxy compound; preparing a second raw material by mixing and reacting an aromatic dihydroxy compound, diaryl carbonate, a phosphorus branching agent, and about 350 ppb (weight) to about 450 ppb (weight) of the catalyst with respect to the amount of aromatic dihydroxy compound; and melt-polymerizing about 100 parts by weight of the first raw material and about 1 part by weight to about 20 parts by weight of the second raw material. The branched polycarbonate prepared by the method can exhibit excellent properties in terms of heat resistance, color stability and/or fluidity due to small catalyst amount.

### CROSS-REFERENCE TO RELATED APPLICATION

This application claims priority under 35 USC Section 119 to and the benefit of Korean Patent Application No. 10-2012-0157678, filed Dec. 28, 2012, the entire disclosure of which is incorporated herein by reference.

### FIELD OF THE INVENTION

The present invention relates to a branched polycarbonate and a method for preparing the same.

### BACKGROUND OF THE INVENTION

Because of excellent properties such as mechanical strength, heat resistance, impact resistance, transparency and the like, polycarbonate resins are widely used for disks, transparent sheets, impact resistant films, and the like, and demand for the same has been continuously increasing. Recently, polycarbonate has been increasingly used in the manufacture of exterior sheets of buildings, soundproof walls on roads, and the like through extrusion molding. However, typical polycarbonate resins have a viscosity that is not substantially changed even by high shear force during extrusion molding, and a low coefficient of viscosity of the polycarbonate resins limits molding operations in the production of a product having a uniform thickness by blow molding. Thus, there is a need for a polycarbonate resin having different properties from typical polycarbonate resins in terms of fluidity and viscosity.

Accordingly, polycarbonates of various branch structures have been developed. A typical branched polycarbonate has a structure similar to phenol or bisphenol A (BPA) in order to maintain reactivity of the polycarbonate and employs a compound containing at least three hydroxyl groups (—OH).

For example, U.S. Pat. No. 3,799,953 discloses branched polycarbonate prepared using 1,1,1-tris-(4-hydroxyphenyl)ethane and 1-[α-methyl-α-(4′-hydroxyphenyl)ethyl]-4-[α′,α′-bis(4′-hydroxyphenyl)ethyl]benzene. U.S. Pat. No. 4,959,422 discloses a method for preparing polycarbonate using a compound containing at least three epoxy groups as a branching agent.

However, since existing branching agents containing hydroxyl terminal groups have a high amount of terminal OH groups due to preparation of the branched polycarbonate, there is a problem in that heat stability of polycarbonate can be deteriorated. Moreover, a phenoxy group-terminal branching agent, such as disclosed in Korean Patent Publication No. 2010-0072836A, is inconveniently prepared through additional reaction between an existing hydroxyl group-terminal branching agent and diphenyl carbonate. Moreover, when the branching agent containing hydroxyl groups is used in the preparation of branched polycarbonate through melt polymerization, prepared products have a higher yellow index (YI) than typical polycarbonates due to low heat stability at high temperatures.

Therefore, there is an urgent need for a branched polycarbonate, which can prevent deterioration of heat stability, does not increase an amount of terminal OH groups in the prepared branched polycarbonate, and exhibits excellent properties in terms of color stability and fluidity when the branched polycarbonate is prepared through melt polymerization.

### SUMMARY OF THE INVENTION

The present invention provides branched polycarbonate, which can exhibit excellent properties in terms of heat resistance, color stability and fluidity by reducing an amount of a catalyst, and a method for preparing the same.

The present invention also relates to a method for preparing branched polycarbonate. The method includes: preparing a first raw material by mixing and reacting an aromatic dihydroxy compound, diaryl carbonate, and about 60 ppb (weight) to about 140 ppb (weight) of a catalyst with respect to the amount of aromatic dihydroxy compound; preparing a second raw material by mixing and reacting an aromatic dihydroxy compound, diaryl carbonate, a phosphorus branching agent, and about 350 ppb (weight) to about 450 ppb (weight) of the catalyst with respect to the amount of aromatic dihydroxy compound; and melt-polymerizing about 100 parts by weight of the first raw material and about 1 part by weight to about 20 parts by weight of the second raw material.

In one embodiment, the aromatic dihydroxy compound may be represented by Formula 1:

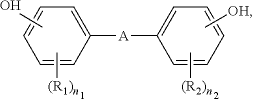

wherein A is a single bond, an unsubstituted C₁ to C₃₀ hydrocarbon group, an O— or S-containing C₁ to C₃₀ hydrocarbon group, a halogen acid ester group, a carbonic acid ester group, —CO—, —S—, or —SO₂—; R₁ and R₂ are the same or different and are each independently a substituted or unsubstituted C₁ to C₃₀ hydrocarbon group; and n₁ and n₂ are the same or different and are each independently an integer from 0 to 4.

In one embodiment, the phosphorus branching agent may be represented by Formula 2:

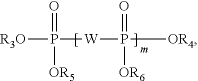

wherein W is a substituted or unsubstituted C₁ to C₂₀ hydrocarbon group, an O— or S-containing C₁ to C₂₀ hydrocarbon group, —O—, or —S—; R₃, R₄, R₅ and R₆ are the same or different and are each independently a substituted or unsubstituted C₁ to C₂₀ hydrocarbon group; and m is an integer from 0 to 4.

In one embodiment, in the first and second raw materials, the diaryl carbonate may be present in an amount of about 100 parts by mole to about 120 parts by mole based on about 100 parts by mole of the aromatic dihydroxy compound, and in the second raw material, the phosphorus branching agent may be present in an amount of about 0.01 parts by mole to about 10 parts by mole based on about 100 parts by mole of the aromatic dihydroxy compound.

The present invention also relates to a branched polycarbonate. The branched polycarbonate is prepared by the method for preparing a branched polycarbonate, and has a degree of branching from about 0.6 to about 5.

In one embodiment, the branched polycarbonate may include a unit represented by Formula 3:

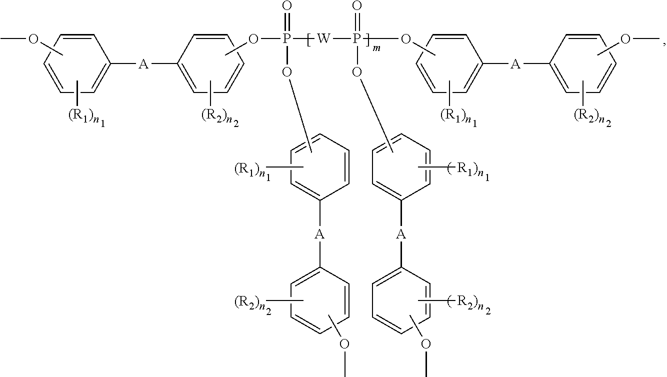

wherein W is a substituted or unsubstituted C₁ to C₂₀ hydrocarbon group, an O— or S-containing C₁ to C₂₀ hydrocarbon group, —O—, or —S—; A is a single bond, an unsubstituted C₁ to C₃₀ hydrocarbon group, an O— or S-containing C₁ to C₃₀ hydrocarbon group, a halogen acid ester group, a carbonic acid ester group, —CO—, —S—, or —SO₂—; R₁ and R₂ are the same or different and are each independently a substituted or unsubstituted C₁ to C₃₀ hydrocarbon group; n₁ and n₂ are the same or different and are each independently an integer from 0 to 4; and m is an integer from 0 to 4.

In one embodiment, the branched polycarbonate may have a post-injection molding yellow index (YI) of about 4.5 or less and a difference (ΔYI) of about 3 or less between a yellow index after injection molding and a yellow index after being held (staying) at 340° C. for 5 minutes.

In one embodiment, the branched polycarbonate may have a concentration of terminal hydroxyl groups of about 25% or less based on the total concentration of terminal groups.

In one embodiment, the branched polycarbonate may include about 0.1 mol % to about 3 mol % of a unit represented by Formula 3.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

According to embodiments of the present invention, a method for preparing branched polycarbonate includes: (A) preparing a first raw material by blending and reacting an aromatic dihydroxy compound, diaryl carbonate, and about 60 ppb (parts per billion, weight) to about 140 ppb (weight) of a catalyst based on the total amount of aromatic dihydroxy compound in the first raw material; (B) preparing a second raw material by blending and reacting the aromatic dihydroxy compound, the diaryl carbonate, a phosphorus branching agent, and about 350 ppb (weight) to about 450 ppb (weight) of the catalyst based on the total amount of aromatic dihydroxy compound in the second raw material; and (C) melt-polymerizing about 100 parts by weight of the first raw material and about 1 part by weight to about 20 parts by weight of the second raw material.

The aromatic dihydroxy compound may be represented by Formula 1:

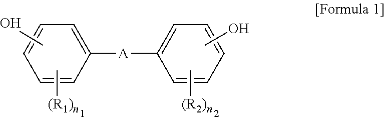

wherein A is a single bond, an unsubstituted C₁ to C₃₀ hydrocarbon group, an O— or S-containing C₁ to C₃₀ hydrocarbon group, a halogen acid ester group, a carbonic acid ester group, —CO—, —S—, or —SO₂—; R₁ and R₂ are the same or different and are each independently a substituted or unsubstituted C₁ to C₃₀ hydrocarbon group; and n₁ and n₂ are the same or different and are each independently an integer from 0 to 4.

Unless otherwise stated, the term “hydrocarbon group” means a saturated or unsaturated, linear, branched or cyclic hydrocarbon group. A “linear” type hydrocarbon group may include 1 to 30 carbon atoms, a “branched” type hydrocarbon group may have two or more carbon atoms, and up to 30 carbon atoms, and a “cyclic” hydrocarbon group may have four or more carbon atoms, and up to 30 carbon atoms. In addition, the term “substituted” means that a hydrogen atom is substituted with a substituent such as C₁ to C₃₀ alkyl, C₁ to C₃₀ haloalkyl, C₁ to C₂₀ alkoxy, C₆ to C₃₀ aryl, C₆ to C₃₀ aryloxy, halogen, a combination thereof, and the like. In exemplary embodiments, the substituent is C₁ to C₁₀ alkyl, for example C₁ to C₃ alkyl. Further, unless otherwise stated, the term “alkyl” means a linear, branched or cyclic alkyl.

In one embodiment, A may be a single bond, substituted or unsubstituted C₁ to C₃₀ alkylene, substituted or unsubstituted C₂ to C₅ alkenylene, substituted or unsubstituted C₂ to C₅ alkylidene, substituted or unsubstituted C₅ to C₆ cycloalkylene, substituted or unsubstituted C₅ to C₆ cycloalkenylene, substituted or unsubstituted C₅ to C₁₀ cycloalkylidene, substituted or unsubstituted C₆ to C₃₀ arylene, substituted or unsubstituted C₁ to C₂₀ alkoxylene, a halogen acid ester group, a carbonic acid ester group, —CO—, —S—, or —SO₂—, and R₁ and R₂ may be each independently substituted or unsubstituted C₁ to C₃₀ alkyl or substituted or unsubstituted C₆ to C₃₀ aryl.

Examples of the aromatic dihydroxy compound may include without limitation 4,4′-dihydroxydiphenyl, 2,2-bis-(4-hydroxyphenyl)-propane, 2,4-bis-(4-hydroxyphenyl)-2-methylbutane, 1,1-bis-(4-hydroxyphenyl)-cyclohexane, 2,2-bis-(3-chloro -4-hydroxyphenyl)-propane, 2,2-bis-(3,5-dichloro-4-hydroxyphenyl)-propane, and the like, and combinations thereof. In exemplary embodiments, the aromatic dihydroxy compound includes 2,2-bis-(4-hydroxyphenyl)-propane, 2,2-bis-(3,5-dichloro-4-hydroxyphenyl)-propane, and/or 1,1-bis -(4-hydroxyphenyl)-cyclohexane, for example, 2,2-bis-(4-hydroxyphenyl)-propane, called “bisphenol-A”.

The diaryl carbonate may be any typical diaryl carbonate used in melt polymerization of polycarbonate. Examples of the diaryl carbonate include without limitation diphenyl carbonate, ditolyl carbonate, bis(chlorophenyl)carbonate, m-cresyl carbonate, dinaphthyl carbonate, bis(diphenyl)carbonate, diethyl carbonate, dimethyl carbonate, dipropyl carbonate, dibutyl carbonate, methyl ethyl carbonate, methyl propyl carbonate, ethyl propyl carbonate, dicyclohexyl carbonate, and the like. These are used alone or in combination thereof. In exemplary embodiments, the diaryl carbonate includes diphenyl carbonate.

In each of the first and second raw materials, based on about 100 parts by mole of the aromatic dihydroxy compound, the diaryl carbonate is present in an amount of about 100 parts by mole to about 120 parts by mole, for example about 105 parts by mole to about 118 parts by mole. In some embodiments, the diaryl carbonate is present in an amount of about 100, 101, 102, 103, 104, 105, 106, 107, 108, 109, 110, 111, 112, 113, 114, 115, 116, 117, 118, 119, or 120 parts by mole. Further, according to some embodiments of the present invention, the amount of the diaryl carbonate can be in a range from about any of the foregoing amounts to about any other of the foregoing amounts.

Within this range, commercialized polycarbonate can secure mechanical properties and preparation stability.

The phosphorus branching agent includes at least three alkoxy groups and/or aryloxy groups, and allows the branched polycarbonate to be prepared without increasing the amount of terminal hydroxyl groups of the polycarbonate. For example, the phosphorus branching agent may employ a phosphorus branching agent represented by Formula 2:

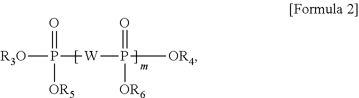

wherein W is a substituted or unsubstituted C₁ to C₂₀ hydrocarbon group, an O— or S-containing C₁ to C₂₀ hydrocarbon group, —O— , or —S—; R₃, R₄, R₅ and R₆ are the same or different and are each independently a substituted or unsubstituted C₁ to C₂₀ hydrocarbon group; and m is an integer from 0 to 4, for example 0 or 1.

In one embodiment, W may be substituted or unsubstituted C₁ to C₁₂ alkylene, substituted or unsubstituted C₄ to C₁₂ cycloalkylene, substituted or unsubstituted C₆ to C₁₈ arylene, —OR—O— (wherein R is C₁ to C₁₂ alkylene, C₄ to C₁₂ cycloalkylene, or C₆ to C₁₈ arylene), —S—RS— (wherein R is C₁ to C₁₂ alkylene, C₄ to C₁₂ cycloalkylene, or C₆ to C₁₈ arylene), —O—, or —S—. For example, R may include a unit derived from biphenol and/or bisphenol. In addition, R₃, R₄, R₅ and R₆ may each independently be substituted or unsubstituted C₁ to C₁₀ alkyl, substituted or unsubstituted C₆ to C₁₈ aryl, halogen- or C₁ to C₁₀ alkoxy-substituted C₁ to C₁₀ alkyl, or halogen- or C₁ to C₁₀ alkoxy-substituted C₆ to C₁₈ aryl.

In the second raw material, based on about 100 parts by mole of the aromatic dihydroxy compound, the phosphorus branching agent is present in an amount of about 0.01 parts by mole to about 10 parts by mole, for example about 0.01 parts by mole to about 5 parts by mole, and as another example about 0.1 parts by mole to about 3 parts by mol. In some embodiments, the phosphorus branching agent may be present in an amount of about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, 5, 6, 7, 8, 9, or 10 parts by mole. Further, according to some embodiments of the present invention, the amount of the phosphorus branching agent can be in a range from about any of the foregoing amounts to about any other of the foregoing amounts.

Within this range, the branched polycarbonate can exhibit excellent properties in terms of fluidity, such as molding processability, and the like, and preparation stability.

According to embodiments of the invention, the branched polycarbonate may maximize the degree of branching, exhibit excellent color stability, and minimize a yellow index (YI) using the phosphorus branching agent. The branched polycarbonate may greatly increase weight average molecular weight even when a small amount of the branching agent is used as described above, and may exhibit excellent polymerization stability and be economically prepared by melt polymerization.

However, the phosphorus branching agent has low polymerization reactivity and requires addition of the catalyst in an amount of about 2 or more times that of typical methods for preparing polycarbonate. In this case, there is a problem that an excess of the catalyst deteriorates heat stability of polycarbonate products.

Thus, the present invention takes a process in which the catalyst and the raw materials are mixed and reacted to form an oligomer in a single process and the oligomer is used in melt polymerization, and divides the reaction materials into a first raw material preparation process and a second raw material preparation process, which differ in amounts of branching agent and catalyst, and the first and second raw materials are used in melt polymerization, so that the amount of the catalyst is lowered in a final product while preventing deterioration in heat stability.

According to the present invention, the catalyst may be any typical catalyst used in melt polymerization of polycarbonate without limitation. For example, the catalyst may be an alkali metal and/or alkali earth metal catalyst. Examples of the alkali metal and alkali earth metal catalysts include without limitation LiOH, NaOH, KOH, and the like. These are used alone or in combination thereof.

In the first raw material, the catalyst is present in an amount of about 60 ppb (weight) to about 140 ppb (weight), for example about 80 ppb (weight) to about 120 ppb (weight), and as another example about 90 ppb (weight) to about 110 ppb (weight), with respect to the amount of aromatic dihydroxy compound in the first raw material. In some embodiments, the catalyst is present in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, or 140 ppb. Further, according to some embodiments of the present invention, the amount of the catalyst in the first raw material can be in a range from about any of the foregoing amounts to about any other of the foregoing amounts.

In the second raw material, the catalyst is present in an amount of about 350 ppb (weight) to about 450 ppb (weight), for example about 380 ppb (weight) to about 420 ppb (weight), and as another example about 390 ppb (weight) to about 410 ppb (weight), with respect to the amount of aromatic dihydroxy compound in the second raw material. In some embodiments, the catalyst is present in an amount of about 350, 351, 352, 353, 354, 355, 356, 357, 358, 359, 360, 361, 362, 363, 364, 365, 366, 367, 368, 369, 370, 371, 372, 373, 374, 375, 376, 377, 378, 379, 380, 381, 382, 383, 384, 385, 386, 387, 388, 389, 390, 391, 392, 393, 394, 395, 396, 397, 398, 399, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, or 450 ppb. Further, according to some embodiments of the present invention, the amount of the catalyst in the second raw material can be in a range from about any of the foregoing amounts to about any other of the foregoing amounts.

Within these ranges, the branched polycarbonate, which can exhibit excellent properties in terms of the degree of branching, color stability, and the like, can be stably prepared without deterioration of heat stability, even though an excess of the catalyst is not used.

In one embodiment, the preparation of the first raw material (operation (A)) may be carried out in the same manner as in a typical process in which raw materials are mixed to prepare an oligomer with the amount of a catalyst used in the preparation of the aromatic dihydroxy compound, diaryl carbonate, and typical polycarbonate. For example, this process can be carried out at about 140° C. to about 230° C., for example about 160° C. to about 220° C., for about 1 hour to about 10 hours. Here, the conversion ratio of the aromatic dihydroxy compound may be about 70% or more, and the conversion ratio of the diaryl carbonate may be about 65% or more. Within this range, reaction stability can be secured.

In addition, the oligomer in the first raw material may have a weight average molecular weight from about 350 g/mol to about 700 g/mol.

In one embodiment, preparation of the second raw material (operation (B)) may be carried out under the same conditions as in the process for mixing the first raw material and preparing the oligomer using the aromatic dihydroxy compound, the diaryl carbonate and the phosphorus branching agent, and the catalyst due to the use of the phosphorus branching agent. For example, this process can be carried out at about 140° C. to about 230° C., for example about 160° C. to about 220° C., for about 1 hour to about 10 hours. Here, the conversion ratio of the aromatic dihydroxy compound may be about 70% or more, and the conversion ratio of the diaryl carbonate may be about 65% or more. Within this range, reaction stability can be secured.

In addition, the oligomer in the second raw material may have a weight average molecular weight from about 500 g/mole to about 1,000 g/mol.

In one embodiment, melt polymerization (operation (C)) is a process of transferring about 100 parts by weight of the first raw material and about 1 part by weight to about 20 parts by weight, for example about 5 parts by weight to about 15 parts by weight of the second raw material, to a polymerization reactor and melt-polymerizing the same. In some embodiments, the process uses about 1, 2, 3, 4, 5, 6, 7, 8, 9, 10, 11, 12, 13, 14, 15, 16, 17, 18, 19, or 20 parts by weight of the second raw material. Further, according to some embodiments of the present invention, the amount of the second raw material can be in a range from about any of the foregoing amounts to about any other of the foregoing amounts.

In this process, since the amount of the second raw material including the phosphorus branching agent, causing the use of an excess of the catalyst, is small, and the amount of the catalyst in the final branched polycarbonate is lowered, the branched polycarbonate is prevented from deterioration of heat stability.

Melt polymerization may be carried out under the same conditions as in typical melt polymerization except that the first and second raw materials are used. For example, melt polymerization may be carried out at about 200° C. to about 300° C., for example about 220° C. to about 290° C. Within this range, there are merits in terms of reaction rates and reduction of side reactions. Here, reaction pressure may be reduced to about 0.1 Torr to about 70 Torr, and stirring may be carried out under the condition of high temperature and reduced pressure for about 10 minutes to 10 hours, without being limited thereto. In addition, melt polymerization may be separately carried out in first to fourth polymerization reactors as listed in Examples. By-products such as phenol, and the like, generated during the reaction, may be recovered by typical methods.

The branched polycarbonate according to embodiments of the invention may be prepared by the method as described above, and may include a unit represented by Formula 3:

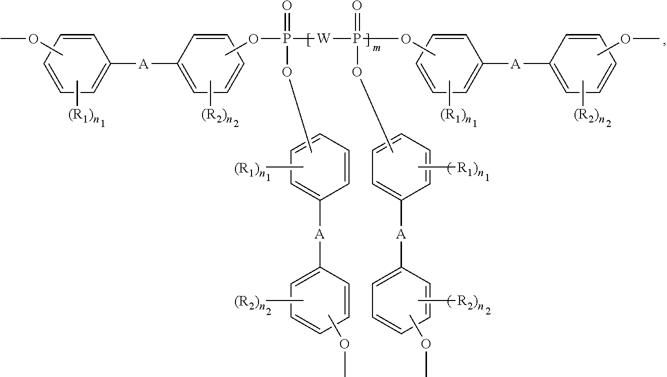

wherein W, A, R₁, R₂, m, n₁ and n₂ are defined as in Formulae 1 and 2.

In one embodiment, the branched polycarbonate has a post-injection molding yellow index (YI) of about 4.5 or less, for example from about 2 to about 3, and has a difference (ΔYI) of about 3 or less between a yellow index after injection molding and a yellow index after staying at 340° C. for 5 minutes, for example from about 1 to about 2, thus exhibiting excellent heat stability.

The branched polycarbonate can have a degree of branching from about 0.6 to about 5, for example, from about 1 to about 4, and as another example from about 1.2 to about 3.9, and thus can be branched to a high degree. In some embodiments, the branched polycarbonate can have a degree of branching of about 0.6, 0.7, 0.8, 0.9, 1, 2, 3, 4, or 5. Further, according to some embodiments of the present invention, the degree of branching can be in a range from about any of the foregoing amounts to about any other of the foregoing amounts.

The branched polycarbonate may have a concentration of terminal hydroxyl groups of about 25% or less relative to the concentration of total terminal groups, for example, from about 10% to about 22%. In some embodiments, the branched polycarbonate may have a concentration of terminal hydroxyl groups of about 10, 11, 12, 13, 14, 15, 16, 17, 18, 19, 20, 21, 22, 23, 24, or 25%. Further, according to some embodiments of the present invention, the concentration of terminal hydroxyl groups can be in a range from about any of the foregoing amounts to about any other of the foregoing amounts.

Within this range, the branched polycarbonate can have excellent color stability and a low yellow index.

For example, the branched polycarbonate may include about 0.1 mol % to about 3 mol % of a unit represented by Formula 3. Within this range, the branched polycarbonate can exhibit excellent fluidity, such as molding processability, and preparation stability. In some embodiments, the branched polycarbonate may include the unit represented by Formula 3 in an amount of about 0.1, 0.2, 0.3, 0.4, 0.5, 0.6, 0.7, 0.8, 0.9, 1, 2, or 3 mol %. Further, according to some embodiments of the present invention, the amount of the unit represented by Formula 3 can be in a range from about any of the foregoing amounts to about any other of the foregoing amounts.

The branched polycarbonate may have a weight average molecular weight from about 30,000 g/mole to about 70,000 g/mol as measured by gel permeation chromatography (GPC).

Next, the present invention will be explained in more detail with reference to the following examples. However, it should be understood that these examples are provided for illustration only and are not to be in any way construed as limiting the present invention.

### EXAMPLES

### Example 1

In a first raw material mixing reactor maintained at a temperature of 160° C., 154.8 kg of bisphenol A (BPA), 160.2 kg of diphenyl carbonate (DPC) and 100 ppb (/BPA, weight) of a catalyst (KOH) are placed, followed by heating to 190° C. and stirring for 6 hours, thereby preparing a first raw material. In addition, in a second raw material mixing reactor maintained at a temperature of 160° C., 17.2 kg of bisphenol A (BPA), 17.8 kg of diphenyl carbonate (DPC), 1.0 kg of a phosphorus branching agent (bisphenol A diphosphate) and 400 ppb (/BPA, weight) of a catalyst (KOH) are placed, followed by heating to 190° C. and stirring for 6 hours, thereby preparing a second raw material. Next, the first raw material is transferred to a first polymerization reactor at a rate of 13.0 kg/hr and the second raw material is transferred thereto at a rate of 1.5 kg/hr, and a continuous reaction is started. In a main reaction, the first polymerization reactor is maintained at 220° C. and 70 Torr, and an average residence time is 1 hour. Next, the mixture of the first and second raw materials is continuously transferred to a second polymerization reactor, which is maintained at 265° C. and 30 Torr, and the average residence time is 1 hour. Next, the mixture of the first and second raw materials is continuously transferred to a third polymerization reactor, which is maintained at 265° C. and 1,000 Pa, and the residence time is 1 hour. Next, the mixture is continuously transferred to a fourth polymerization reactor, which is maintained at 265° C. and 400 Pa, and the average residence time is 1 hour. Then, a final polymerized material is prepared as pellet-shaped branched polycarbonate through an extruder.

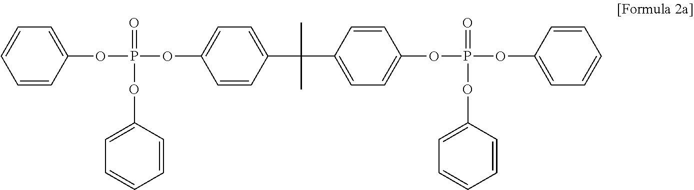 [SMILES: CC(C)(c1ccc(OP(=O)(Oc2ccccc2)Oc2ccccc2)cc1)c1ccc(OP(=O)(Oc2ccccc2)Oc2ccccc2)cc1]

### Example 2

A branched polycarbonate is prepared in the same manner as in Example 1 except that 2.0 kg of the phosphorus branching agent represented by Formula 2a is used, the second raw material is transferred at a rate of 1.54 kg/hr, and the fourth polymerization reactor is maintained at 360 Pa.

### Example 3

A branched polycarbonate is prepared in the same manner as in Example 1 except that 3.0 kg of the phosphorus branching agent represented by Formula 2a is used, that the second raw material is transferred at a rate of 1.60 kg/hr, and the fourth polymerization reactor is maintained at 330 Pa.

### Example 4

A branched polycarbonate is prepared in the same manner as in Example 1 except that 4.0 kg of the phosphorus branching agent represented by Formula 2a is used, that the second raw material is transferred at a rate of 1.63 kg/hr, and the fourth polymerization reactor is maintained at a pressure of 300 Pa.

### Example 5

A branched polycarbonate is prepared in the same manner as in Example 1 except that 5.0 kg of the phosphorus branching agent represented by Formula 2a is used, the second raw material is transferred at a rate of 1.67 kg/hr, and the fourth polymerization reactor is maintained at a pressure of 260 Pa.

### Comparative Example 1

In a raw material mixing reactor maintained at a temperature of 160° C., 172.0 kg of bisphenol A (BPA), 178.0 kg of diphenyl carbonate (DPC), 1.0 kg of a phosphorus branching agent represented by Formula 2a and 400 ppb (/BPA, weight) of a catalyst (KOH) are placed, followed by heating to 190° C. and stirring for 6 hours, thereby preparing a raw material. Next, the raw material is transferred to a first polymerization reactor at a rate of 1.45 kg/hr, and a continuous reaction is started. In a main reaction, the first polymerization reactor is maintained at 220° C. and 70 Torr, and the residence is 1 hour. Next, the raw material is continuously transferred to a second polymerization reactor, which is maintained at 265° C. and 30 Torr, and the average residence time is 1 hour. Next, the raw material is continuously transferred to a third polymerization reactor, which is maintained at 265° C. and 1,000 Pa, and the average residence time is 1 hour. Next, the raw material is continuously transferred to a fourth polymerization reactor, which is maintained at 265° C. and 500 Pa, and the average residence time is 1 hour. Then, a final polymerized material is prepared as pellet-shaped branched polycarbonate through an extruder.

### Comparative Example 2

A branched polycarbonate is prepared in the same manner as in Comparative Example 1 except that 2.5 kg of the phosphorus branching agent represented by Formula 2a is used and the fourth polymerization reactor is maintained at 460 Pa.

### Comparative Example 3

A branched polycarbonate is prepared in the same manner as in Comparative Example 1 except that 5.0 kg of the phosphorus branching agent represented by Formula 2a is used and the fourth polymerization reactor is maintained at 400 Pa.

After drying at 120° C. for 4 hours, the branched polycarbonate of each of the examples and the comparative examples is subjected to injection molding under the conditions of a molding temperature of 290° C. and a mold temperature of 70° C. using a 10 Oz. injection molding machine, thereby preparing a 3 mm thick specimen. The specimen is evaluated by the following methods, and results are shown in Table 1.

Evaluation of Properties

(1) Weight average molecular weight and number average molecular weight (unit: g/mol): Measurement is carried out using a GPC-TDA (Viscotek Co., Ltd.) and chloromethane as a solvent.

(2) Melt index (MI) and melt index ratio (MIR): After melt indices are respectively obtained at 300° C./1.2 kg and at 300° C./11.2 kg, MIR is calculated based on MI (300° C./11.2 kg)/MI (300° C./1.2 kg).

(3) Impact resistance (Izod impact strength, unit: kgf/cm·cm): After Izod impact strength is measured 5 times on a ⅛″ thick notched Izod specimen at 25° C. in accordance with ASTM D256, an average value of 5 measurement values is applied.

(4) Yellow index (YI): After a yellow index is measured 5 times on the same specimen using a colorimeter ND-1001 DP (Nippon Denshoku Kogyo Co., Ltd.), and the measurement values are averaged.

(5) Measurement of ΔYI: After staying in a barrel at 340° C. for 5 minutes, the dried branched polycarbonate is subjected to injection molding under the condition of a molding temperature of 290° C. and a mold temperature of 70° C. using a 10 Oz. injection molding machine, thereby preparing a 3 mm thick specimen. A yellow index (YI) of the specimen (specimen after staying at 340° C. for 5 minutes) is measured by the YI measurement method. Next, by subtracting a YI (specimen before staying at 340° C.) value (an average value of at least two specimens) from a YI (specimen after staying at 340° C. for 5 minutes) value (an average value of at least two specimens), ΔYI is calculated. Here, ΔYI is inversely proportional to heat stability.

TABLE 1

| | | | | | | | Comparative | | |
|---|---|---|---|---|---|---|---|---|---|
| | | Example | | | | | Example | | |
| | | 1 | 2 | 3 | 4 | 5 | 1 | 2 | 3 |
| First | BPA (kg) | 154.8 | 154.8 | 154.8 | 154.8 | 154.8 | 172 | 172 | 172 |
| raw | DPC (kg) | 160.2 | 160.2 | 160.2 | 160.2 | 160.2 | 178 | 178 | 178 |
| material | Phosphorus branching | — | — | — | — | — | 1.0 | 2.5 | 5.0 |
| | agent (kg) | | | | | | | | |
| | Catalyst (ppb/BPA) | 100 | 100 | 100 | 100 | 100 | 400 | 400 | 400 |
| | Transfer rate (kg/hr) | 13.0 | 13.0 | 13.0 | 13.0 | 13.0 | 14.5 | 14.5 | 14.5 |
| Second | BPA (kg) | 17.2 | 17.2 | 17.2 | 17.2 | 17.2 | — | — | — |
| raw | DPC (kg) | 17.8 | 17.8 | 17.8 | 17.8 | 17.8 | — | — | — |
| material | Phosphorus branching | 1.0 | 2.0 | 3.0 | 4.0 | 5.0 | — | — | — |
| | agent (kg) | | | | | | | | |
| | Catalyst (ppb/BPA) | 400 | 400 | 400 | 400 | 400 | — | — | — |
| | Transfer rate (kg/hr) | 1.50 | 1.54 | 1.58 | 1.63 | 1.67 | — | — | — |

| | | | | | | | | |
|---|---|---|---|---|---|---|---|---|
| Amount of catalyst in product | 131 | 132 | 133 | 133 | 134 | 400 | 400 | 400 |
| (ppb/BPA) | | | | | | | | |
| Weight average molecular | 26.4 | 29.8 | 33.0 | 35.2 | 38.8 | 26.4 | 31.8 | 38.4 |
| weight (×1000) | | | | | | | | |
| Number average molecular | 12.4 | 12.0 | 11.3 | 10.5 | 9.8 | 12.6 | 11.6 | 10.1 |
| weight (×1000) | | | | | | | | |
| PDI(Mw/Mn) | 2.13 | 2.48 | 2.92 | 3.35 | 3.96 | 2.1 | 2.7 | 3.8 |
| MIR | 11.2 | 12.5 | 14.4 | 15.2 | 15.9 | 11.1 | 13.7 | 16.0 |
| Impact resistance | 77.2 | 70.2 | 57.5 | 41.7 | 15.7 | 78.3 | 66.4 | 14.2 |
| YI | 2.4 | 2.7 | 2.6 | 2.8 | 2.9 | 2.6 | 2.9 | 2.7 |
| ^{Δ}YI | 1.7 | 1.5 | 1.8 | 1.7 | 1.6 | 3.6 | 3.3 | 3.5 |

From the results shown in Table 1, it can be seen that the branched polycarbonate prepared by the method for preparing a branched polycarbonate according to the invention (Examples 1 to 5) exhibits excellent properties or exhibits insignificant changes in impact resistance, MIR, and the like, and exhibits extremely excellent heat stability (ΔYI), as compared with the branched polycarbonate of Comparative Examples 1 to 3 in which an excess of the catalyst is used.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

What is claimed is:

1. A method for preparing branched polycarbonate comprising:
preparing a first raw material by mixing and reacting an aromatic dihydroxy compound, diaryl carbonate, and about 60 ppb (weight) to about 140 ppb (weight) of a catalyst with respect to the amount of aromatic dihydroxy compound;
preparing a second raw material by mixing and reacting an aromatic dihydroxy compound, diaryl carbonate, a phosphorus branching agent, and about 350 ppb (weight) to about 450 ppb (weight) of the catalyst with respect to the amount of aromatic dihydroxy compound; and
melt-polymerizing about 100 parts by weight of the first raw material and about 1 part by weight to about 20 parts by weight of the second raw material.

2. The method according to claim 1, wherein the aromatic dihydroxy compound is represented by Formula 1: 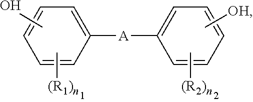
wherein A is a single bond, an unsubstituted C₁ to C₃₀ hydrocarbon group, an O— or S-containing C₁ to C₃₀ hydrocarbon group, a halogen acid ester group, a carbonic acid ester group, —CO—, —S—, or —SO₂—; R₁ and R₂ are the same or different and are each independently a substituted or unsubstituted C₁ to C₃₀ hydrocarbon group; and n₁ and n₂ are the same or different and are each independently an integer from 0 to 4.

3. The method according to claim 1, wherein the phosphorus branching agent is represented by Formula 2: 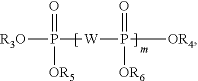
wherein W is a substituted or unsubstituted C₁ to C₂₀ hydrocarbon group, an O— or S-containing C₁ to C₂₀ hydrocarbon group, —O— , or —S—; R₃, R₄, R₅ and R₆ are the same or different and are each independently a substituted or unsubstituted C₁ to C₂₀ hydrocarbon group; and m is an integer from 0 to 4.

4. The method according to claim 1, wherein in each of the first and second raw materials, the diaryl carbonate is present in an amount of about 100 parts by mole to about 120 parts by mole based on about 100 parts by mole of the aromatic dihydroxy compound, and in the second raw material, the phosphorus branching agent is present in an amount of about 0.01 parts by mole to about 10 parts by mole based on about 100 parts by mole of the aromatic dihydroxy compound.

5. A branched polycarbonate prepared by the method for preparing a branched polycarbonate according to claim 1, having a degree of branching from about 0.6 to about 5.

6. The branched polycarbonate according to claim 5, comprising a unit represented by Formula 3: 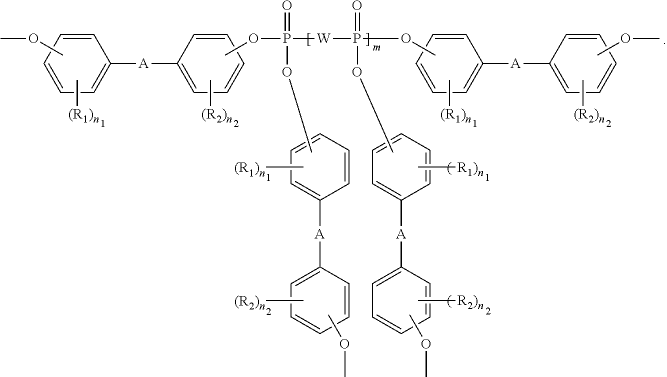
wherein W is a substituted or unsubstituted C₁ to C₂₀ hydrocarbon group, an O— or S-containing C₁ to C₂₀ hydrocarbon group, —O— , or —S—; A is a single bond, an unsubstituted C₁ to C₃₀ hydrocarbon group, an O— or S-containing C₁ to C₃₀ hydrocarbon group, a halogen acid ester group, a carbonic acid ester group, —CO—, —S—, or —SO₂—; R₁ and R₂ are the same or different and are each independently a substituted or unsubstituted C₁ to C₃₀ hydrocarbon group; n₁ and n₂ are the same or different and are each independently an integer from 0 to 4; and m is an integer from 0 to 4.

7. The branched polycarbonate according to claim 5, having a post-injection molding yellow index (YI) of about 4.5 or less and a difference (ΔYI) of about 3 or less between a yellow index after injection molding and a yellow index after staying at 340° C. for 5 minutes.

8. The branched polycarbonate according to claim 5, having a concentration of terminal hydroxyl groups of about 25% or less based on the concentration of total terminal groups.

9. The branched polycarbonate according to claim 6, comprising about 0.1 mol % to about 3 mol % of a unit represented by Formula 3.
